(19) United States
(12) Patent Application Publication
(10) Pub. No.: US 2021/0047710 A1
(43) Pub. Date: Feb. 18, 2021

(54) GE-DOPED AUSN SOLDER ALLOYS

(71) Applicant: INDIUM CORPORATION, Utica, NY (US)

(72) Inventors: Joseph C. Wu, Utica, NY (US); Christopher Testa, Utica, NY (US); Carmen Salvatore, Whitesboro, NY (US); Brian Reid, Norwich, NY (US)

(21) Appl. No.: 16/542,910

(22) Filed: Aug. 16, 2019

(51) Int. Cl. C22C 5/02; B23K 35/30; B23K 35/02

(52) U.S. Cl. CPC C22C 5/02; B23K 2101/40; B23K 35/0227; B23K 35/3013

(57) ABSTRACT

Implementations of the disclosure are directed to improving the ductility of a tin-enriched AuSn solder alloy by doping the solder alloy with Germanium (Ge). The final AuSnGe alloy may consist of 75 to 80 wt % Au, 20 to 25 wt % Sn, and 0.05 to 1.5 wt % Ge.

### DESCRIPTION OF THE RELATED ART

Eutectic gold tin (AuSn) with a composition of 80Au20Sn is a unique material. With a tensile strength of 40,000 PSI, AuSn is much more rigid than typical tin solders. The strength is more closely compared to the silver brazes that melt above 500° C. This particular alloy of AuSn is used as a solder for high-temperature lead-free soldering applications because it has a melting temperature of about 280° C., which is lower than the 350° C. transition temperature into braze materials. For example, it may be prescribed for die-attach and lid sealing on high-reliability electronics packages. Use of a eutectic AuSn alloy in soldering applications may present some issues.

One issue may present itself in soldering applications due to the plating on the bonding surface. A common practice is to cover a low-solderability surface, such as KOVAR, stainless steel, or ceramic, with nickel (Ni) and then add a gold plating over the Ni to protect it from oxidation. During the soldering process, the Sn in the solder preform scavenges (dissolves) the Au plating into a solution, increasing the gold composition in the solder joint.

Gold scavenging during the reflow process may result in the solder joint having an increased melting temperature, causing premature freezing, and creating small voids in the final solder joint. These voids are poor (thermal and electrical) conductors and may create hot spots in a die-attach bond line. This is illustrated by FIG. 1, which shows a phase diagram of the AuSn alloy.

One way to prevent this from happening is to use a tin-rich off-eutectic (lower Au concentration) AuSn solder alloy to compensate for the plating. For example, a 79Au21Sn or 78Au22Sn alloy may be used for this purpose. If solid state diffusion of tin to an underlying gold bond surface occurs with this solder composition, the melting temperature may drop as the tin is depleted in the solder composition. As such, the use of the Sn-rich solder may ensure that the alloy will remain molten during reflow soldering, obtaining a better reflow result.

### BRIEF SUMMARY OF EMBODIMENTS

Implementations of the disclosure are directed to improving the ductility of a tin-enriched AuSn solder alloy by doping the solder alloy with Germanium (Ge). The final AuSnGe alloy may consist of 75 to 80 wt % Au, 20 to 25wt % Sn, and 0.05 to 1.5wt % Ge. The proportion of Au to Sn by wt % may be kept at a ratio of about 75:25 or higher to ensure that the formation temperature of prime δ-AuSn of the tin-enriched AuSn alloy is lower than temperature at which the doped Ge precipitates to form solid solution AuGe. In some implementations, the wt % ratio of Au to Sn is between 75:25 and 79:21. For example, the wt % ratio of Au to Sn may be 75:25, 76:24, 77:23, 78:22, or 79:21. In some implementations, the solder alloy has 0.5 to 1.0 wt % of Ge.

In some implementations the solder alloy is a solder ribbon or solder foil. In some implementations, the solder alloy is a solder preform (e.g., a preform cut from a ribbon or foil). In some implementations, the solder alloy is a solder wire.

In one embodiment, a method includes: placing a solder preform on a surface of a substrate to form an assembly; and reflow soldering the assembly to form a solder joint from the solder preform, where the solder preform consists of: 75 wt % to 80 wt % of Au; 20 wt % to 25 wt % of Sn; and 0.05 wt % to 1.5 wt % of Ge. In implementations, prior to placing the solder preform, the method further includes: punching the solder preform from a solder ribbon. In implementations, the surface of the substrate is Au or Au-coated. In implementations, the solder preform is placed between the surface of the substrate and a semiconductor component to form the assembly.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The technology disclosed herein, in accordance with one or more various embodiments, is described in detail with reference to the included figures. The figures are provided for purposes of illustration only and merely depict example implementations. Furthermore, it should be noted that for clarity and ease of illustration, the elements in the figures have not necessarily been drawn to scale.

FIG. 1 shows a phase diagram of an AuSn alloy.

FIG. 2A is a micrograph showing coarse grains of prime δ-AuSn formed in an Au78Sn22 cast bar.

FIG. 2B is a micrograph showing that during ribbon formation, the coarse grains of prime δ-AuSn are rolled to elongated, thick strings.

FIG. 3 is a micrograph showing the microstructure of 78Au22Sn doped with between 0.05 wt % and 1.5 wt % of Ge, in accordance with implementations of the disclosure.

FIG. 4 is a differential scanning calorimetry (DSC) plot of an AuSnGe solder alloy, in accordance with implementations of the disclosure.

FIG. 5A is a micrograph showing the microstructure of a AuSnGe alloy after it is rolled into a solder ribbon structure, in accordance with implementations of the disclosure.

FIG. 5B is a micrograph showing the microstructure of a 78Au22Sn alloy after it is rolled into a ribbon.

FIG. 6A is a chart including plots showing the results of bending tests conducted on five specimens of a Ge-doped 78Au22Sn ribbon, in accordance with implementations of the disclosure.

FIG. 6B is a chart including showing the results of bending tests conducted on five specimens of a 78Au22Sn ribbon without Ge doping.

FIG. 7A shows the bonding interface between a solder joint formed from a Ge-doped 78Au22Sn solder alloy, and the Cu of a copper coupon, in accordance with implementations of the disclosure.

FIG. 7B shows a close up of the Ge-doped 78Au22Sn solder joint of FIG. 7A.

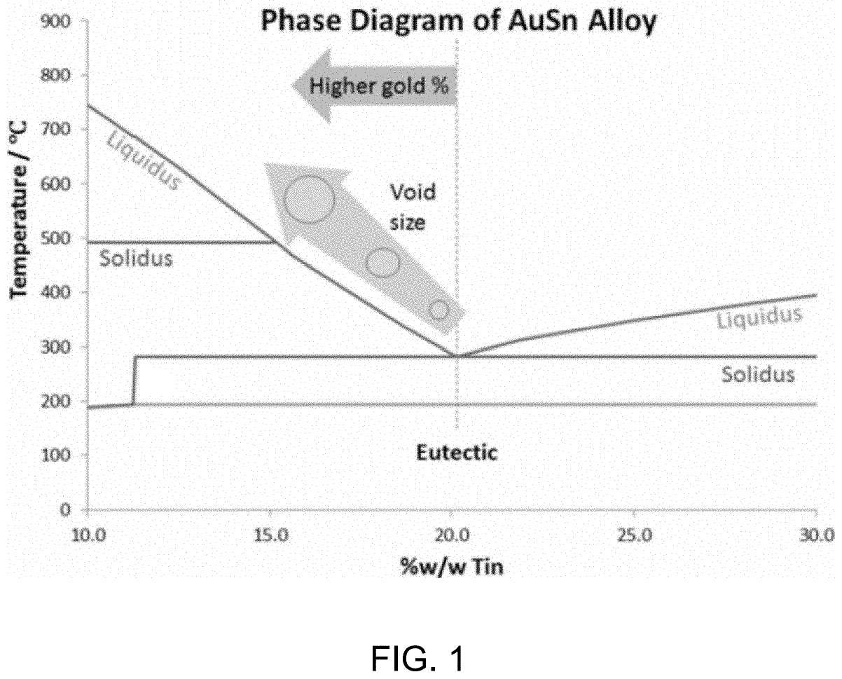

The figures are not intended to be exhaustive or to limit the invention to the precise form disclosed. It should be understood that the invention can be practiced with modification and alteration, and that the disclosed technology be limited only by the claims and the equivalents thereof.

### DETAILED DESCRIPTION OF THE EMBODIMENTS

As noted above, one way to prevent gold scavenging during a reflow soldering process involving eutectic AuSn is to use a tin-rich off-eutectic (lower Au concentration) AuSn solder alloy to compensate for the plating. However tin-enriched Au—Sn solders may suffer from brittleness and poor ductility due to the presence of coarse grains of δ-AuSn. In particular, as the cast tin-enriched AuSn alloy begins to solidify, the alloy may form prime δ-AuSn before eutectic solidification. As solidification progresses, the prime δ-AuSn may grow up to coarse grains of δ-AuSn. These coarse grains of δ-AuSn may cause the AuSn solder alloy to be hard and brittle, with poor ductility. A solder ribbon formed from the alloy may be prone to shattering. When the tin-enriched AuSn alloy is rolled into a solder ribbon, the coarse grains of δ-AuSn will be rolled to elongated strings, making the solder prone to shattering.

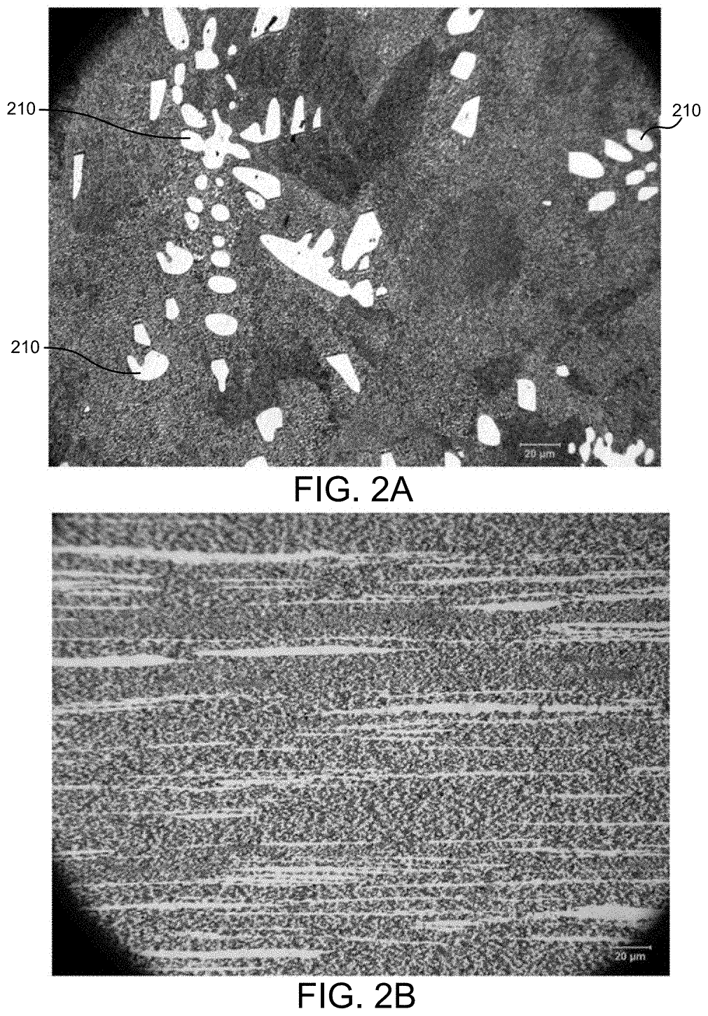

This problem is illustrated by FIGS. 2A-2B, which respectively show micrograph images of Au78Sn22 alloy in a cast bar and the alloy after rolling into a ribbon. FIG. 2A is a micrograph showing coarse grains 210 (white-colored) of prime δ-AuSn formed in a 78Au22Sn cast bar. FIG. 2B is a micrograph showing that during ribbon formation, the coarse grains of prime δ-AuSn are rolled to elongated, thick strings. As such, the coarse grains of prime δ-AuSn in the cast bar and the elongated, thick strings it rolled into in the ribbon contribute to brittleness of the solder ribbon. During handling and/or subsequent processing, the solder ribbon may break along these elongated strings. In particular it may be difficult to roll and/or punch the solder ribbon. Furthermore, if a tin-rich off-eutectic Au—Sn solder alloy is used as a solder alloy for reflow soldering, coarse δ-AuSn may form in the solder joint after reflow, causing a more brittle solder joint.

To address this problem and other problems that may arise in the use of tin-rich AuSn solder alloys, various implementations of the disclosure are directed to improving the ductility of a tin-enriched AuSn solder alloy by doping the solder alloy with Germanium (Ge). During solidification of the cast AuSnGe solder alloy, the doped Ge precipitates to form solid solution AuGe at a temperature above the formation temperature of prime δ-AuSn of the tin-enriched AuSn alloy. The precipitation temperature of AuGe may be above 358° C., while the liquidus temperature of tin enriched AuSn may be below 358° C. The AuGe precipitates provide a heterogeneous reaction environment for the AuSn solidification, such that the formation of prime δ-AuSn is dominated in nucleation rather than grain growth, resulting in prime δ-AuSn grains having a finer grain size. Particularly, the formation of coarse grain δ-AuSn, and its long strings after rolling, may be avoided, resulting in a solder ribbon that is more ductile and easier to manufacture.

In implementations, between about 0.05 wt % and 1.5 wt % of Ge may be doped into a tin-enriched AuSn alloy. To ensure that the doped Ge precipitates to form solid solution AuGe instead of pure Ge at a temperature above the formation temperature of prime δ-AuSn, the amount of Ge in the AuSnGe solder alloy may be kept at about 1.5 wt % or lower.

Prior to doping, the tin-enriched solder alloy may have between about 20 wt % and 25 wt % of Sn, and a remainder of Au. The final AuSnGe alloy may have about 75 to 80 wt % Au, about 20 to 25wt % Sn, and about 0.05 to 1.5wt % Ge. The proportion of Au to Sn by wt % may be kept at a ratio of about 75:25 or higher to ensure that the formation temperature of prime δ-AuSn of the tin-enriched AuSn alloy is lower than temperature at which the doped Ge precipitates to form solid solution AuGe.

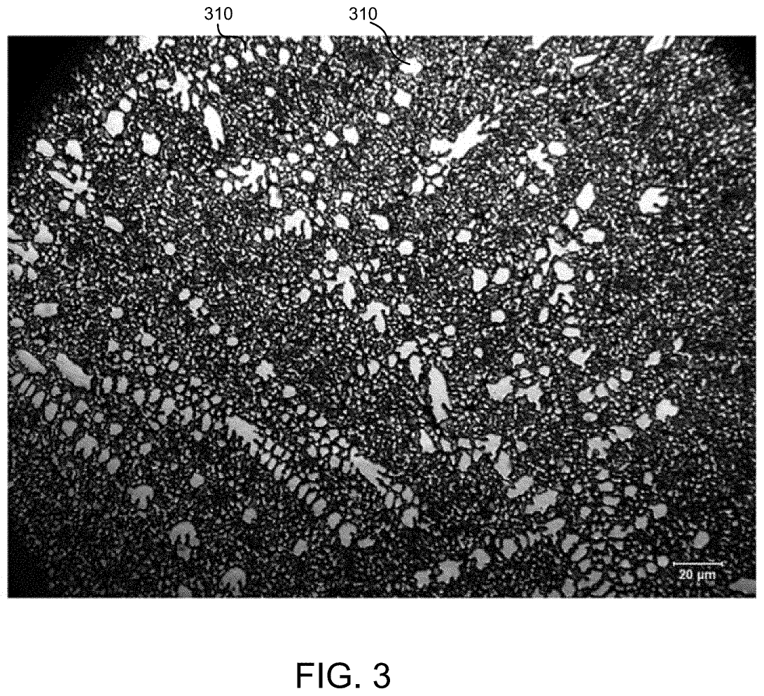

FIG. 3 is a micrograph showing the microstructure of 78Au22Sn doped with 0.75wt % of Ge (e.g., 0.75 mcg of Ge added for every 100 mcg of 78Au22Sn), in accordance with implementations of the disclosure. As illustrated, the prime δ-AuSn grains 310 in the Ge-doped 78Au22Sn alloy of FIG. 3 are finer than those in the regular 78Au22Sn alloy of FIG. 2A. As also depicted by FIG. 3, the Ge-doping modifies the structure of the δ-AuSn grains to round spheroids.

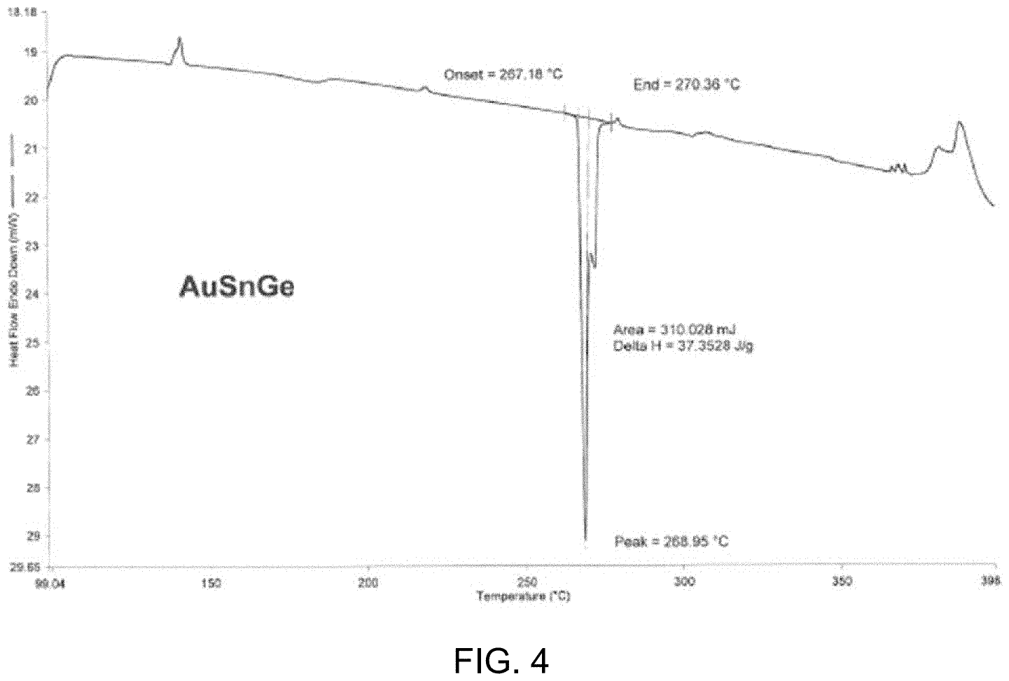

FIG. 4 is a differential scanning calorimetry (DSC) plot of the 78Au22Sn—0.75Ge solder alloy of FIG. 3, in accordance with implementations of the disclosure. As shown by the DSC curve, the solder contains hypereutectic AuSn components with peaks in the 267° C. to 270° C. temperature range, and high temperature AuGe precipitates with peaks in the 360° C. to 380° C. temperature range.

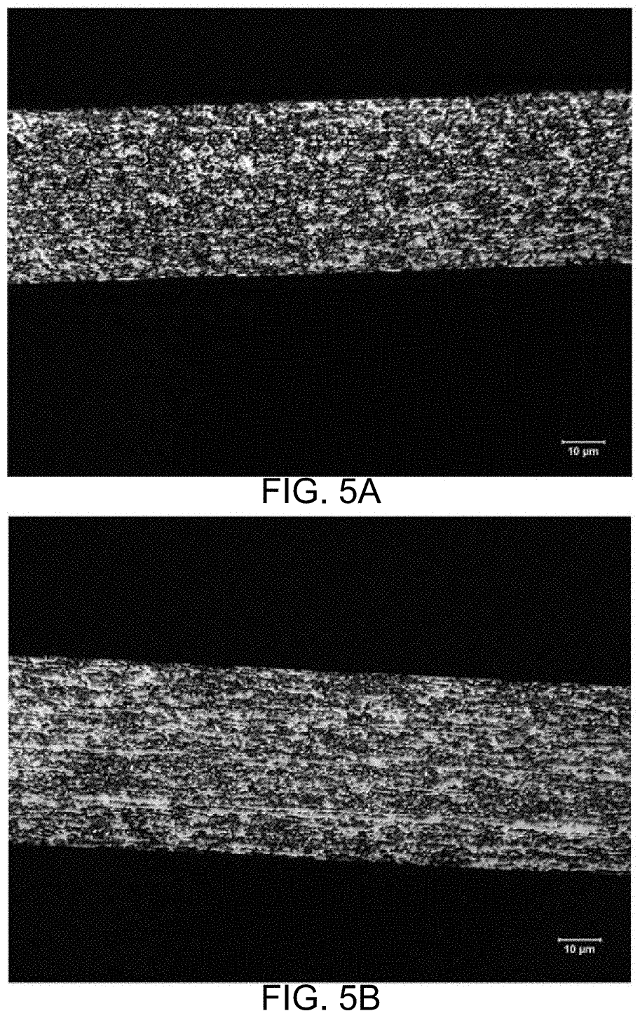

FIG. 5A is a micrograph showing the microstructure of the AuSnGe alloy of FIG. 3 after it is rolled into a solder ribbon structure, in accordance with implementations of the disclosure. As illustrated, after rolling, the majority of the δ-AuSn grains of the solder ribbon remain as fine particles. Little to no long strings are visually apparent in the microstructure of the ribbon. This may be attributed to the grain refining of prime δ-AuSn contributed by doping with Ge. By contrast, FIG. 5B is a micrograph showing the microstructure of a 78Au22Sn alloy after it is rolled into a ribbon. Several long strings of δ-AuSn are visually apparent in the 78Au22Sn ribbon.

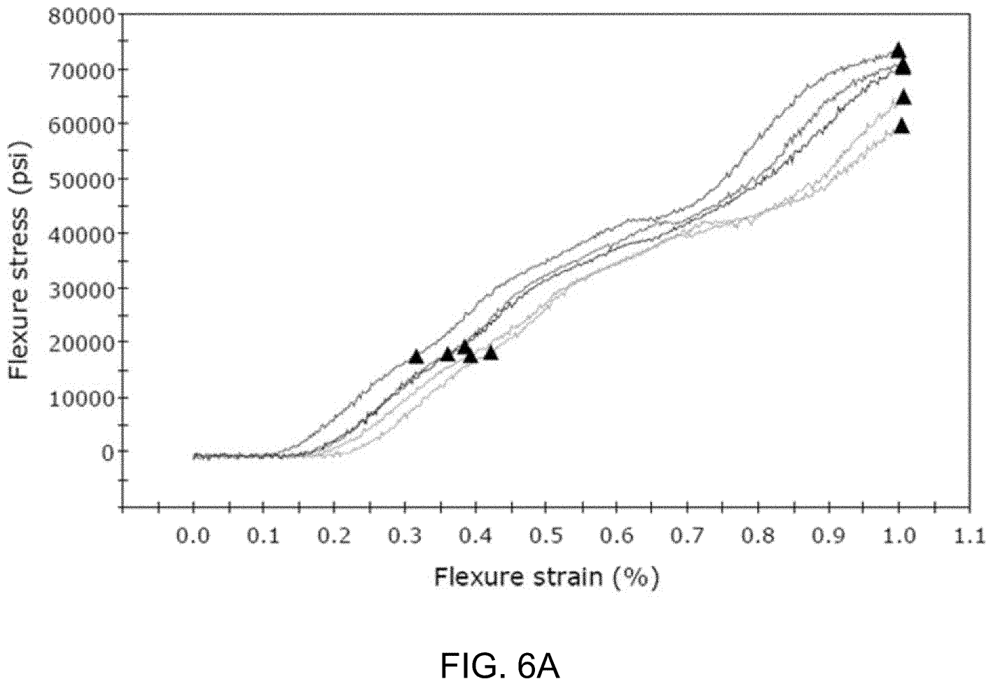

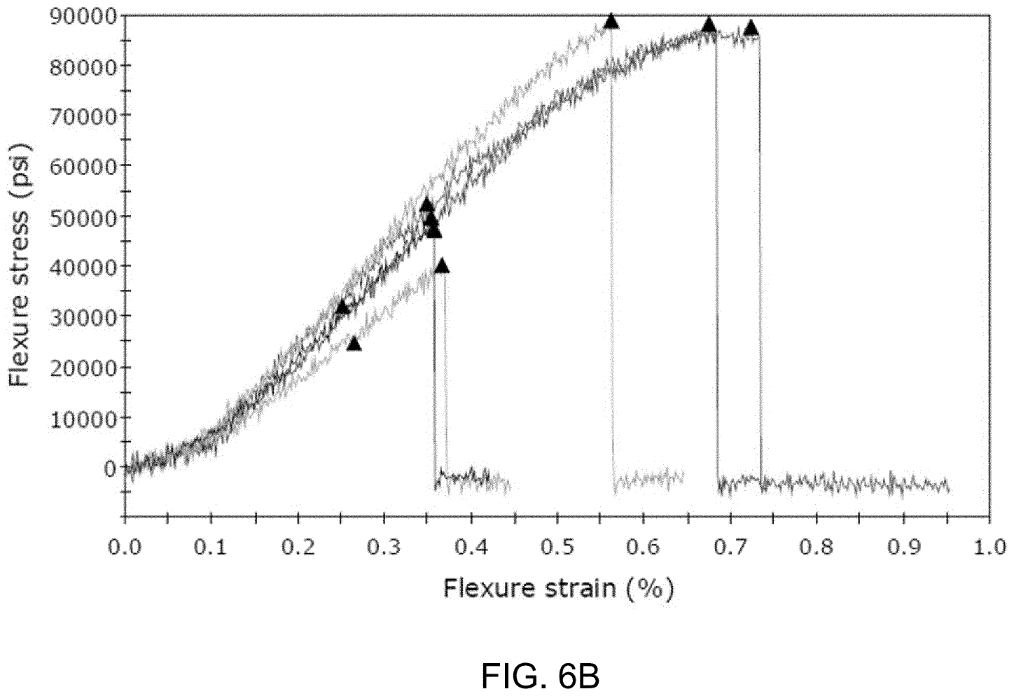

Bending tests were conducted on specimens of Ge-doped 78Au22Sn solder ribbons and specimens of a 78Au22Sn solder ribbon without Ge doping. FIG. 6A is a chart including plots showing the results of bending tests conducted on five specimens of a 78Au22Sn—0.75Ge ribbon in accordance with implementations of the disclosure, whereas FIG. 6B is a chart including showing the results of bending tests conducted on five specimens of a 78Au22Sn ribbon without Ge doping. The plots show flexure stress (psi) as a function of flexure strain (%). All tests were conducted at room temperature. The support span was 10.0 mm, cross head rate was 0.125 in/min, and specimen thickness was about 0.002 to 0.003 in. As shown by the bending tests of FIG. 6A, the specimens of the Ge-doped 78Au22Sn ribbon all passed the bending test, with not a single one breaking. By contrast, as shown by the bending tests of FIG. 6B, the specimens of the 78Au22Sn ribbon all broke from bending after exceeding a certain flexure strain % (e.g., all tested samples broke at flexure strain % between 0.3% and 0.8%). The results of the bending tests indicate that the Ge-doped 78Au22Sn ribbon is more ductile than the 78Au22Sn ribbon. Additional bending tests under similar testing conditions were conducted on specimens of Ge-doped 78Au22Sn solder ribbons that were doped with concentrations of Ge between 0.05 and 1.5 wt % other than 0.75 wt %. Similar to the results for the 78Au22Sn—0.75Ge ribbon, the specimens all passed the bending tests.

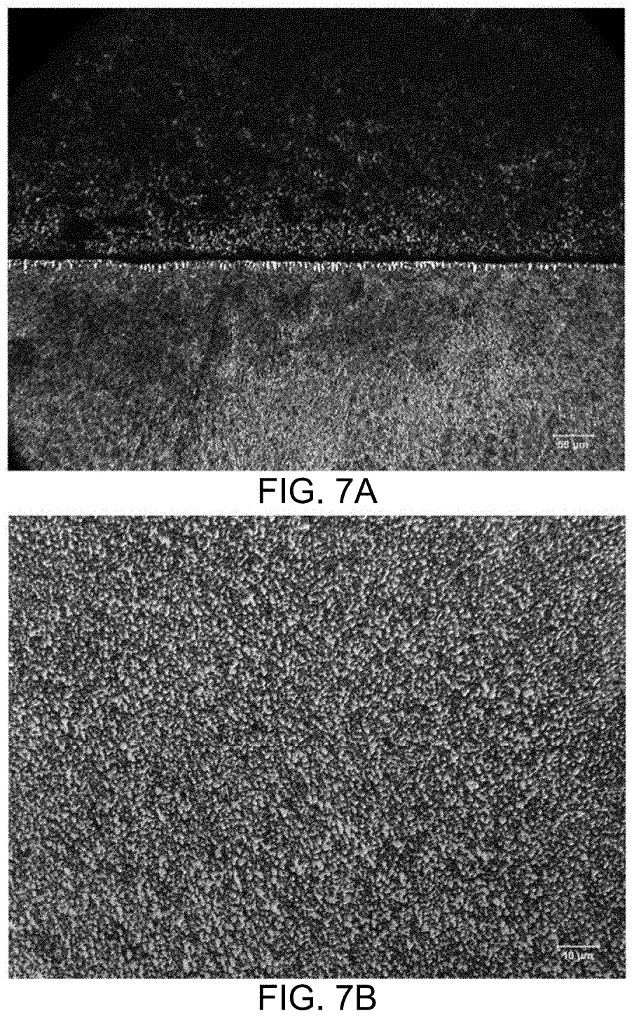

Reflow soldering tests were conducted on a specimen of a 0.75Ge-doped 78Au22Sn solder ribbon by reflowing it onto a copper coupon, in accordance with implementations of the disclosure. FIGS. 7A-7B show the results of the copper coupon test. FIG. 7A shows the bonding interface between a solder joint formed from the Ge-doped 78Au22Sn, and the Cu of the copper coupon. As illustrated, the Ge-doped 78Au22Sn formed a good interface bond with Cu. FIG. 7B shows a close up of the Ge-doped 78Au22Sn solder joint. As shown, the solder joint has a fine, spheroid eutectic structure.

A process for manufacturing and using a Ge-doped AuSn solder alloy in accordance with the disclosure may proceed as follows. The process may begin by casting a AuSnGe solder alloy ingot and then flowing it into a ribbon. The ribbon may be rolled down to a precise thickness. After that, the ribbon may be punched to a preform shape with precise two-dimensional X-Y control. The punched ribbon may be placed onto the surface of a substrate (e.g., an Au, Au-coated, Cu, or Cu-coated substrate) and reflow soldered. For example, a segment of punched ribbon may be placed (e.g., using a pick and place machine) between a semiconductor component (e.g., semiconductor die or groups of dies) and metallic or metal coated substrate to which it is to be bonded, thereby forming an assembly. The assembly may be heated in a semiconductor reflow oven to melt the solder, which when cooled, solidifies, thereby bonding the semiconductor component to the metal coated substrate. In some applications, a flux may be applied prior to reflow.

Although the AuSnGe solder alloys described in the present disclosure have been described primarily in the context of being used in the form of solder ribbons or preforms, they may also be used in the form of solder wire or solder foil.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

The terms “substantially” and “about” used throughout this disclosure, including the claims, are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A solder alloy, consisting of:
75 wt % to 80 wt % of Au;
20 wt % to 25 wt % of Sn; and
0.05 wt % to 1.5 wt % of Ge.

2. The solder alloy of claim 1, wherein the wt % ratio of Au to Sn is between 75:25 and 79:21.

3. The solder alloy of claim 2, wherein the solder alloy has 0.5 to 1.0 wt % of Ge.

4. The solder alloy of claim 2, wherein the wt % ratio of Au to Sn is 75:25.

5. The solder alloy of claim 4, wherein the solder alloy is 78Au22Sn doped with about 0.75 wt % of Ge.

6. The solder alloy of claim 2, wherein the wt % ratio of Au to Sn is 78:22.

7. The solder alloy of claim 1, wherein the solder alloy is a solder ribbon.

8. The solder alloy of claim 1, wherein the solder alloy is a solder foil.

9. The solder alloy of claim 1, wherein the solder alloy is a solder wire.

10. The solder alloy of claim 1, wherein the solder alloy is a solder preform.

11. A method, comprising:
placing a solder preform on a surface of a substrate to form an assembly; and
reflow soldering the assembly to form a solder joint from the solder preform, wherein the solder preform consists of:
75 wt % to 80 wt % of Au;
20 wt % to 25 wt % of Sn; and
0.05 wt % to 1.5 wt % of Ge.

12. The method of claim 11, further comprising: prior to placing the solder preform, punching the solder preform from a solder ribbon.

13. The method of claim 12, wherein the surface of the substrate is Au or Au-coated.

14. The method of claim 11, wherein the surface of the substrate is Au or Au-coated.

15. The solder alloy of claim 14, wherein the wt % ratio of Au to Sn is between 75:25 and 79:21.

16. The solder alloy of claim 15, wherein the wt % ratio of Au to Sn is 75:25.

17. The solder alloy of claim 15, wherein the solder alloy is 78Au22Sn doped with about 0.75 wt % of Ge.

18. The solder alloy of claim 15, wherein the wt % ratio of Au to Sn is 78:22.

19. The solder alloy of claim 11, wherein the wt % ratio of Au to Sn is between 75:25 and 79:21.

20. The method of claim 11, wherein the solder preform is placed between the surface of the substrate and a semiconductor component to form the assembly.
